(19) United States
(12) Patent Application Publication
(10) Pub. No.: US 2014/0258647 A1
(43) Pub. Date: Sep. 11, 2014

(54) RECORDING MEDIUM STORING PERFORMANCE EVALUATION ASSISTANCE PROGRAM, PERFORMANCE EVALUATION ASSISTANCE APPARATUS, AND PERFORMANCE EVALUATION ASSISTANCE METHOD

(71) Applicant: FUJITSU LIMITED, Kawasaki-shi (JP)

(72) Inventor: Tetsutaro MARUYAMA, Kawasaki (JP)

(73) Assignee: FUJITSU LIMITED, Kawasaki-shi (JP)

(21) Appl. No.: 14/166,894

(22) Filed: Jan. 29, 2014

(30) Foreign Application Priority Data
Mar. 11, 2013 (JP) 2013-048485

(51) Int. Cl. G06F 3/06

(52) U.S. Cl. CPC G06F 3/0653; G06F 3/0604; G06F 3/0671
USPC 711/154

(57) ABSTRACT

A characteristic amount for a data redundancy method of a storage apparatus, a characteristic amount for performance of a storage device, a phase change multiplicity, which is a multiplicity at a boundary between a low load and a high load, and the number of read requests per unit time are calculated by using redundancy method information of the storage apparatus, the number of storage devices of the storage apparatus, a used ratio of a used storage area, a ratio of read requests to requests, an average data amount of data read in response to a read request, the number of requests per unit time, and a constant decided based on a processing time for a write request in the storage apparatus and a type of a storage device, and a predicted value of an average response time to a read request is calculated by using the calculated values.

### CROSS-REFERENCE TO RELATED APPLICATION

This application is based upon and claims the benefit of priority of the prior Japanese Patent Application No. 2013-048485, filed on Mar. 11, 2013, the entire contents of which are incorporated herein by reference.

### FIELD

The embodiments discussed herein are related to performance prediction of a storage apparatus.

### BACKGROUND

With the development of a server virtualization technique (VM: virtual Machine) and cloud computing, servers have been being merged or abolished, or implemented as a cloud. Also for storage systems, integration of hardware environments is expected to accelerate. When storage systems are integrated, multi-tenancy, and QoS (Quality of Service) provided by software or operations are needed. With multi-tenancy, data of a user can be protected from other users in an environment where the plurality of users make an access.

Since hardware is prepared for each user, performance of a storage system depends on hardware that configures storage. If storages are integrated, a plurality of users simultaneously use the same hardware. Accordingly, performance prediction and performance evaluation of a storage system of each user on the hardware are important.

As one example of a method for determining performance of a storage system, there exists the following technique. A disk array control unit includes a CPU and statistical information accumulation means. The CPU includes performance determination means for determining whether or not a configuration of a logical disk is suitable. The statistical information accumulation means includes reference response time decision means, into which a load of an input/output command is entered, for deciding an initial reference value and a prediction reference value. The initial reference value is obtained from statistical data acquired by actually measuring processing performance information. The prediction reference value is obtained by adding, to the statistical data, processing performance information acquired when an input/output command process is executed in normal operations.

Here, statistical values directly associated with response performance include three types such as IOPS (Input Output Per Second), which is the number of inputs/outputs per unit time (I/O frequency), an average response (response time), and a multiplicity. The multiplicity is a value obtained by counting the number of I/Os, which are being issued at a certain moment (issued but a response has not been received yet), and by averaging the numbers of I/Os per unit time. These values have a relationship of “(multiplicity)=(I/O frequency)×(response)”.

As one example of a method for enabling prediction of response performance, there exists a method for predicting a response based on a multiplicity.
Patent Document 1: Japanese Laid-open Patent Publication No. 2010-113383
Non-Patent Document 1: Abigail Lebrecht, “Queueing network models of Zoned RAID”, January, 2010, Imperial College Longon
Non-Patent Document 2: A. Gulati, et al, “Pesto: Online Storage Performance Management in Virtualized Datacenters”, SOCC '11 Proceedings of the 2nd ACM Symposium on Cloud Computing Article No. 19

### SUMMARY

According to one aspect of the embodiment, a performance evaluation assistance program causes a computer to execute the following processes. The computer obtains redundancy method information, the number of storage devices, a used ratio, a ratio of read requests, an average data amount, an input/output indicator indicating the number of requests issued per unit time, a constant indicating a processing time, and a storage device constant. The redundancy method information is information about a data redundancy method in a storage apparatus. The number of storage devices is the number of storage devices included in the storage apparatus. The used ratio is a used ratio indicating a ratio of a used storage area within a storage area of a storage device. The ratio of read requests is a ratio of read requests to requests including read and write requests. The average data amount is an average data amount of data read in response to a read request. The constant indicating a processing time is a constant indicating a processing time needed for a write request in the storage apparatus. The storage device constant is a constant decided according to a type of the storage device. The computer calculates a redundancy coefficient indicating a characteristic amount for the data redundancy method of the storage apparatus by using the redundancy method information, the number of storage devices, and the average data amount. The computer calculates a storage device coefficient indicating a characteristic amount for performance of a storage device by using the redundancy method information, the number of storage devices, the average data amount, the used ratio, and the storage device constant. The computer calculates a phase change multiplicity by using the storage device coefficient, the redundancy coefficient, the ratio of read requests, and the constant indicating the processing time. The phase change multiplicity indicates a multiplicity, which is a boundary between a low load phase where a response time is constant with respect to the input/output indicator and a high load phase where a multiplicity indicating the number of overlapping read or write requests from or to the storage apparatus per unit time increases with respect to the input/output indicator. The computer calculates a read request indicator indicating the number of read requests issued per unit time by using the ratio of read requests, and the input/output indicator issued per unit time. The computer calculates a predicted value of an average response time to a read request by using the redundancy coefficient, the storage device coefficient, the phase change multiplicity, and the read request indicator.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a performance evaluation assistance apparatus according to an embodiment.

FIG. 2 is an explanatory diagram of a READ process from a RAID system in this embodiment.

FIG. 3 is an explanatory diagram of a WRITE process to the RAID system in this embodiment.

FIGS. 4A and 4B are explanatory diagrams of an expected value of the number of stripe blocks straddled by READ in this embodiment.

FIG. 5 is a block diagram illustrating hardware of a computer that executes a process for evaluating response performance in this embodiment.

FIG. 6 is a flowchart illustrating a process for evaluating response performance in this embodiment.

FIG. 7 illustrates measurement results of a virtual WRITE cost (V) for each RAID level and each block size of three disks in this embodiment.

FIGS. 8A and 8B are explanatory diagrams of a multiplicity in this embodiment.

FIGS. 9A and 9B are explanatory diagrams of derivation of a performance model in the case of only READ in this embodiment.

FIG. 10 is an explanatory diagram of a performance model when READ and WRITE are mixed in this embodiment.

FIG. 11 is an explanatory diagram of estimation of a phase change multiplicity when READ and WRITE are mixed in this embodiment.

FIG. 12 illustrates actually measured values and predictions of performance of an Online SAS disk RAID5 (4+1) in this embodiment.

FIG. 13 illustrates actually measured values and predictions of performance of an Online SAS disk RAID6 (4+2) in this embodiment.

### DESCRIPTION OF EMBODIMENTS

With the above described method for predicting a response based on a multiplicity, parameters of a model (function) significantly vary depending on measured data. Accordingly, for example, an error between a model created from results measured in a range of a multiplicity 1 to 10 and that created from results measured in a range of a multiplicity larger than 10 becomes very large, posing a problem of prediction accuracy of response performance.

Additionally, as the method for predicting a response based on a multiplicity, a method for linearly approximating a multiplicity is the most accurate. However, an error between an approximate function calculated based on the whole of a measured range and that calculated based on data partially extracted from a measured range is large. Strictly, this means that the multiplicity and the response do not have a relationship of a linear function. Accordingly, this model (function) results in that having a large error depending on a measured range and an applied range. In contrast, an attempt being made to create a precise model, the function becomes very difficult.

One aspect of the present invention provides a technique for improving prediction accuracy of response performance.

Additionally, as a technique for enabling performance prediction, a method for predicting a response based on an I/O frequency is conceivable. As this technique, a method for approximating an I/O frequency with an exponential function is deemed to be highly accurate. However, especially when an average I/O size is large, an error of a response in a medium-level I/O load becomes large.

Furthermore, performance prediction of storage can be also performed with a queuing theory. However, expectations of highly accurate prediction are disappointed although a queuing theory is applied based on actually measured values.

Accordingly, a model for predicting a multiplicity based on an I/O frequency is used in this embodiment. With this model, multiplicity/I/O frequency=response. Therefore, a calculation of a response at an arbitrary I/O frequency is available.

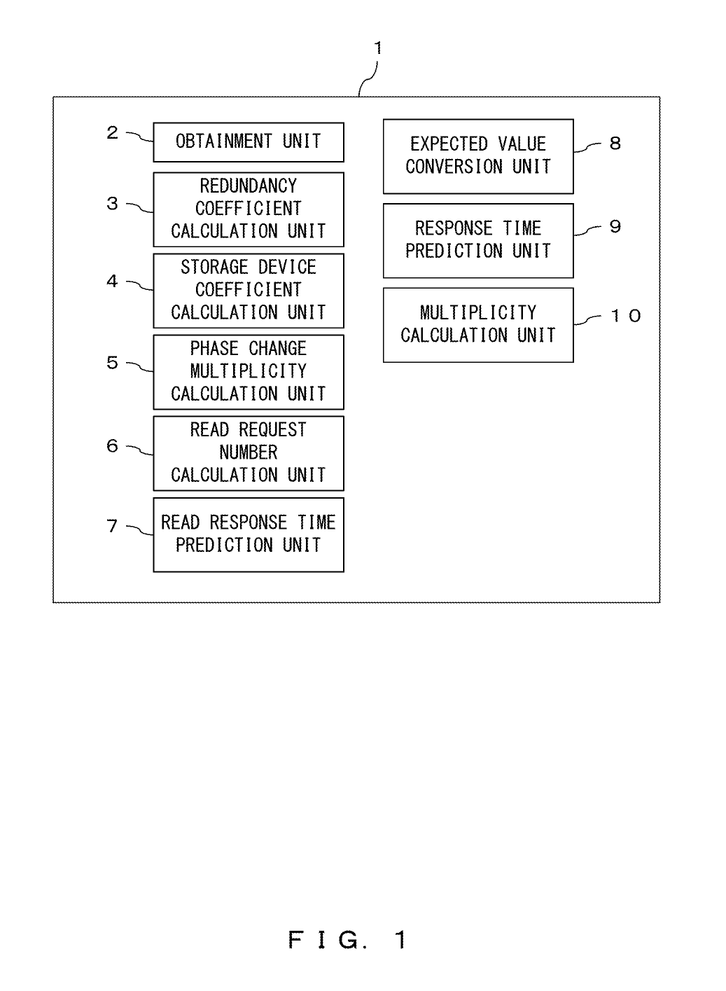

FIG. 1 is a block diagram illustrating a performance evaluation assistance apparatus according to this embodiment. The performance evaluation assistance apparatus 1 includes an obtainment unit 2, a redundancy coefficient calculation unit 3, a storage device coefficient calculation unit 4, a phase change multiplicity calculation unit 5, a read request number calculation unit 6, and a read response time prediction unit 7.

The obtainment unit 2 obtains redundancy method information, the number of storage devices, a used ratio, a ratio of read requests, an average data amount, an input/output indicator that indicates the number of requests issued per unit time, a constant that indicates processing time, and a storage device constant. The redundancy method information is information about a data redundancy method in a storage apparatus, and is, for example, a RAID level to be described later. The number of storage devices is the number of storage devices included in a storage apparatus, and is, for example, a RAID rank (R) to be described later. The used ratio is a used ratio that indicates a ratio of a storage area used in a storage area of a storage device, and is, for example, a used ratio (v) to be described later. The ratio of read requests is a ratio of read requests to requests including read and write requests, and is, for example, a READ ratio (c) to be described later. The average data amount is an average amount of data read in response to a read request, and is, for example, an average block size (r_{R}) to be described later. The number of requests issued per unit time is, for example, an I/O frequency (X) to be described later. The constant that indicates a processing time is a constant that indicates a processing time needed for a write request in the storage apparatus, and is, for example, a virtual WRITE cost (V) to be described later. The storage device constant is a constant decided according to a type of a storage device, and is, for example, a disk constant (D) to be described later. As one example of the obtainment unit, an input interface (I/F) 26 is cited.

The redundancy coefficient calculation unit 3 calculates a redundancy coefficient that indicates a characteristic amount for a data redundancy method of a storage apparatus by using the redundancy method information, the number of storage devices, and the average data amount. The redundancy coefficient is, for example, a RAID coefficient (A) to be described later. As one example of the redundancy coefficient calculation unit 3, the CPU 22 is cited.

The storage device coefficient calculation unit 4 calculates a storage device coefficient indicating a characteristic amount for performance of the storage device by using the redundancy method information, the number of storage devices, the average data amount, and the used ratio. The storage device coefficient is, for example, a disk coefficient (α) to be described later. As one example of the storage device coefficient calculation unit 4, the CPU 22 is cited.

The phase change multiplicity calculation unit 5 calculates a phase change multiplicity by using the storage device coefficient, the redundancy coefficient, the ratio of read requests, and the constant that indicates a processing time. The phase change multiplicity indicates a multiplicity, which is a boundary between a low load phase where a response time is constant with respect to an input/output indicator and a high load phase where a multiplicity that indicates the number of overlapping read or write requests from/to the storage apparatus per unit time increases with respect to the input/output indicator. The phase change multiplicity is, for example, a phase change multiplicity (ε) to be described later. As one example of the phase change multiplicity calculation unit 5, the CPU 22 is cited.

The read request number calculation unit 6 calculates a read request indicator that indicates the number of read requests issued per unit time by using the ratio of read requests, and an input/output indicator issued per unit time. The read request indicator that indicates the number of read requests issued per unit time is, for example, a READ I/O frequency (X_{R}) to be described later. As one example of the read request number calculation unit 6, the CPU 22 is cited.

The read response time prediction unit 7 calculates a predicted value of an average response time to a read request by using the redundancy coefficient, the storage device coefficient, the phase change multiplicity, and the number of read requests issued per unit time. The predicted value of the average response time to the read request is, for example, a READ response (W_{R}) to be described later. As one example of the read response time prediction unit 7, the CPU 22 is cited.

The read response time prediction unit 7 calculates the predicted value (W_{R}) of the average response time to the read request by using the following expression.

$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , {W}_{R} = α A ( {X}_{R} \leq \frac{ɛ}{α A} ) \qquad ( 1 )$$

where A, α, ε, and X_{R} are respectively the redundancy coefficient, the storage device coefficient, the phase change multiplicity, and the number of read requests issued per unit time.

The performance evaluation assistance apparatus 1 further includes an expected value conversion unit 8.

The expected value conversion unit 8 converts the average data amount read from a storage device included in the storage apparatus into an expected value of the number of storage devices from/to which data is read/written in response to a read request or a write request at the time of the read request. The expected value of the number of storage devices is, for example, an expected value (E_{R}), which will be described later, of the number of stripe blocks straddled by READ. As one example of the expected value conversion unit 8, the CPU 22 is cited. At this time, the redundancy coefficient calculation unit 3 and the storage device coefficient calculation unit 4 calculate the redundancy coefficient and the storage device coefficient by using the expected value.

The performance evaluation assistance apparatus 1 still further includes a response time prediction unit 9 and a multiplicity calculation unit 10. The obtainment unit 2 further obtains a response time to a write request. The response time to the write request is, for example, a WRITE response (W_{W}) to be described later.

At this time, the response time prediction unit 9 calculates a predicted value of the average response time to a request issued to the storage apparatus by using the ratio of read requests, the predicted value of the average response time to a read request, and a response time to a write request. The predicted value of the average response time to the request is, for example, a response (W) to be described later. As one example of the response time prediction unit 9, the CPU 22 is cited.

The multiplicity calculation unit 10 calculates a multiplicity that indicates the number of overlapping read or write requests from or to the storage apparatus per unit time by multiplying the predicted value of the average response time to the request by the number of requests issued per unit time. The multiplicity is, for example, a multiplicity (N) to be described later. As one example of the multiplicity calculation unit 10, the CPU 22 is cited.

Details of this embodiment are described below. Storage is a medium (hard disk or the like) for storing data, or an apparatus configured with such media. In this embodiment, RAID (Redundant Arrays of Independent Disks) is cited as one example of an apparatus the performance of which is to be predicted. Therefore, when the term “storage” appears, it is synonymous with RAID.

RAID is a technique for distributing data or storing data with redundancy by using a plurality of storage media, and indicates a technique that improves performance and ensures reliability (data is not lost although a fault occurs in a storage medium), or indicates an apparatus (RAID apparatus) for storing data with the above described technique. The RAID apparatus includes components (a disk device (storage medium), a controller (CPU), a cache (memory)), which are needed to implement RAID and respectively referred to as a RAID disk, a RAID controller, and a RAID cache.

RAID includes various types depending on an implementation method, and numbers are respectively assigned to the types (for example, RAID1, RAID5, RAID6, and the like). These numbers are referred to as RAID levels. For example, a RAID level of the RAID 5 is “5”.

A RAID member represents a data dispersion method and a redundancy configuration method, which vary depending on a RAID level, with a mathematical expression. In the case of RAID5, one parity data for implementing data redundancy for a RAID stripe, which is a data partitioning unit, is created. Therefore, RAID5 is denoted as “4+1” in addition to the number of partitions that configure the stripe. In the case of RAID6, two parties are created for a RAID stripe. Therefore, RAID6 is denoted as “6+2”. The number of RAID disks needed to configure RAID is a value obtained by calculating a denoted expression. For example, 5 disks are needed for RAID5 4+1.

A RAID rank is a value obtained by extracting the number of partitions, which configure a RAID stripe, from a RAID member. For example, a RAID rank of RAID5 4+1 is “4”.

An I/O (Input/Output) has the same meaning as READ/WRITE, and indicates a READ command or a WRITE command, namely, an input/output to/from storage. In terms of storage, READ and WRITE are defined as Output and Input, respectively.

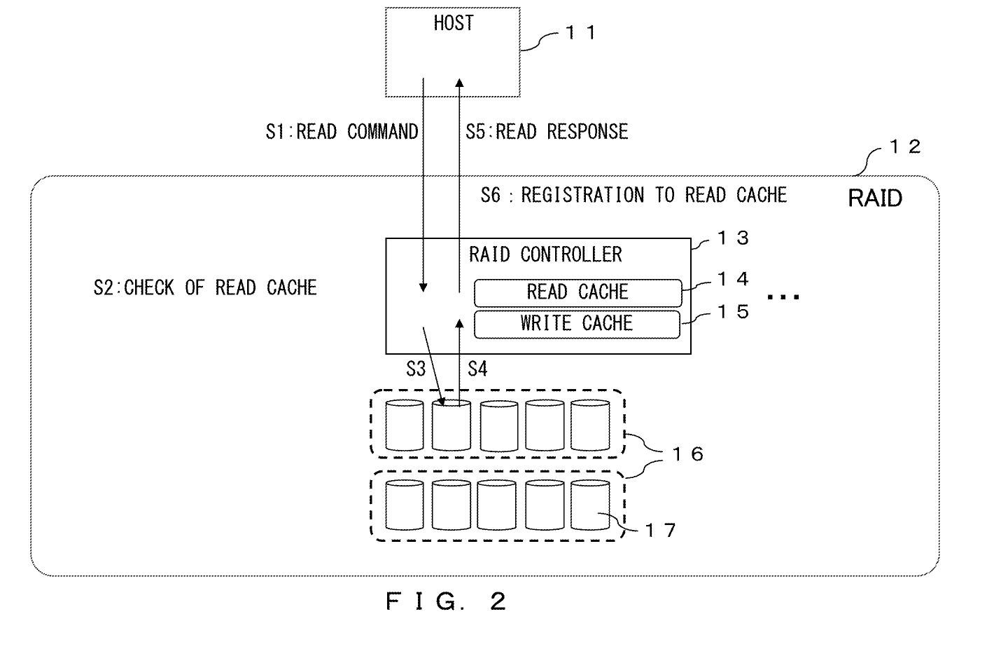

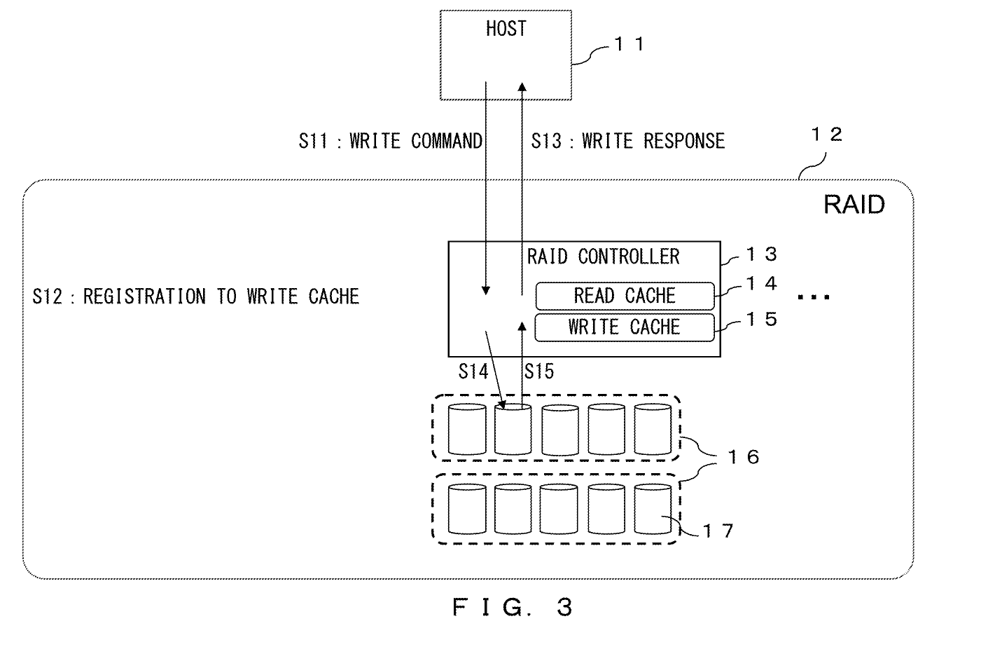

A difference between a READ process and a WRITE process from and to a RAID system is described next with reference to FIGS. 2 and 3.

FIG. 2 is an explanatory diagram of the READ process from the RAID system in this embodiment. FIG. 3 is an explanatory diagram of the WRITE process to the RAID system in this embodiment. A host 11 is a computer connected to the RAID system 12. The RAID system 12 includes a RAID controller 13 and a RAID group 16.

The RAID controller 13 is a controller module for writing data transmitted from the host 11 to a storage medium 17, or for reading data from the storage medium 17 in response to a request issued from the host 11, and controls operations of the RAID group 16. The RAID controller 13 includes a READ cache 14 and a WRITE cache 15. The READ cache 14 is a cache memory used by the RAID controller 13 when a READ command is issued. The WRITE cache 15 is a cache memory used by the RAID controller 13 when a WRITE command is issued.

The RAID group 16 is a minimum unit configured by a certain RAID level and RAID member for a storage medium (disk) that actually configures RAID within the RAID. RAID is internally configured with a plurality of RAID groups 16 composed of various RAID levels and RAID members, which are managed by the RAID controller 13.

In FIG. 2, the READ command is issued from the host 11 (S1). Then, the RAID controller 13 verifies whether or not data to be read is present in the READ cache 14 (S2). When the data is not present in the READ cache 14 (S2), the RAID controller 13 reads the data from the storage medium (disk) 17 on which the data is stored (S3, S4). The RAID controller 13 returns the read data to the host 11 as a response (S5), and registers the data to the READ cache 14 (S6).

This embodiment assumes a random access. Therefore, it is assumed that data requested by the READ command is not present in the READ cache 14 (a READ cache miss occurs by 100%). Accordingly, it is assumed that a READ response takes the amount of time equal to or longer than number×10⁻³[sec].

In FIG. 3, the WRITE command is issued from the host 11 (S11). Then, the RAID controller 13 stores data to be written specified by the WRITE command in the WRITE cache 15 (S12), and immediately returns a response to the host 11 (S13). Then, the RAID controller 13 writes the data to be written, which is stored in the WRITE cache 15, to the storage medium (disk) (S14, S15).

This embodiment assumes that the WRITE cache 15 has an empty space (a WRITE cache hit occurs by 100%). Accordingly, the WRITE response is assumed to take no time of 0 [sec].

Factors that change the processing performance of the RAID system are described next. The factors that change the processing performance of the RAID system include disk characteristics, a RAID configuration, a volume configuration, and workload characteristics. The disk characteristics include a disk capacity, the number of revolutions [rpm: revolution per minute] (=seek time) of a disk. The number of revolutions [rpm] of a disk is taken into account as a disk constant (D) as will be described later.

As a RAID configuration, there exist a RAID level and a RAID member. The RAID member is taken into account as a RAID rank (R).

For the volume configuration, there exists a used volume ratio (v). The used volume ratio (v) indicates a capacity that actually stores data with respect to the capacity of the entire RAID group composed of certain RAID level and RAID member. Assuming that the disk capacity is C, the capacity of the RAID group is represented as CR. Also assuming that a used capacity is L, v=L/CR.

The workload characteristics include an I/O frequency, an average I/O size (=average block size), and a READ-to-WRITE ratio.

The I/O frequency indicates the number of I/Os (Input/Output per second: IOPS) processed per unit time [sec]. An I/O frequency obtained by counting READ commands is referred to as a READ I/O frequency, whereas an I/O frequency obtained by counting WRITE commands is referred to as a WRITE I/O frequency. A total I/O frequency, the READ I/O frequency, and the WRITE I/O frequency are denoted as “X”, “X_{R}”, and “X_{W}”, respectively.

The READ-to-WRITE ratio is taken into account as a READ ratio (C) (C=X_{R}/X).

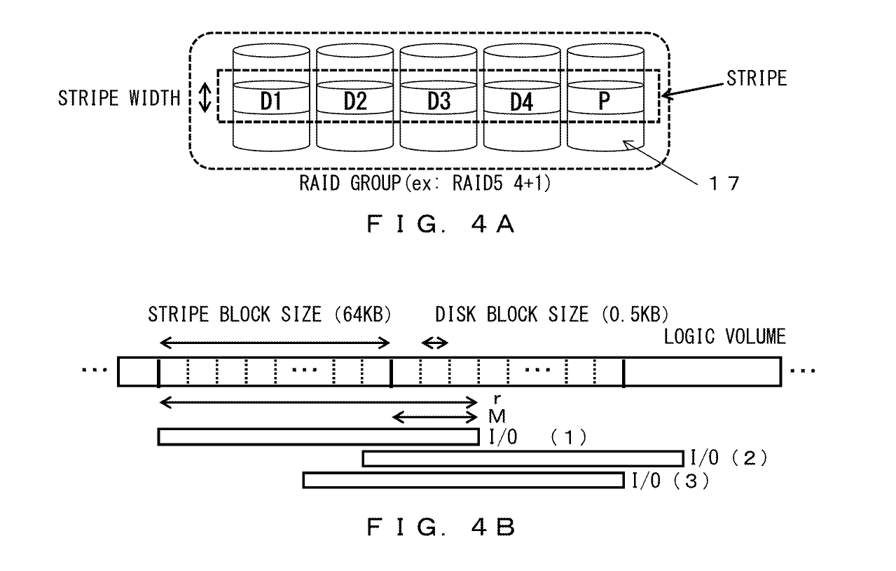

The average I/O size (=average block size) is a size of data transmitted by one request (I/O). The average I/O size is taken into account as an expected value (E_{R}) of the number of stripe blocks straddled by READ, and an expected value (E_{W}) of the number of stripe blocks straddled by WRITE. Here, the expected value of the number of stripe blocks straddled by READ is described with reference to FIGS. 4A and 4B.

FIGS. 4A and 4B are explanatory diagrams of the expected value of the number of stripe blocks straddled by READ in this embodiment. When a block size is different, performance of RAID differs. Namely, as the block size increases, so does the amount of data of an access to a disk, leading to an increase in a response time. However, when a response time is measured only for a single disk, this influence is barely exerted on response performance. It is proved that an actual change of the amount of time needed for a read/write from/to a disk barely exerts an influence on a response depending on a difference of a block size.

However, when a response time is measured for RAID, response performance deteriorates as the block size increases. The reason why the performance is expected to deteriorate is that an I/O is partitioned in units of stripe blocks when the I/O straddles the stripe blocks, and accesses are made to a plurality of disks.

Disks are logically partitioned in units of stripe blocks as illustrated in FIG. 4A, and a stripe is created by stripe blocks (D1 to D4) at the same position of the disks 17 of the RAID group. A parity (P) is created to maintain redundancy in this unit.

Exactly identical disks (identical capacities) are used as the disks within the RAID group 16. In the case of RAID5 or RAID6, a disk for storing parity in each of stripes differs depending on a stripe.

Namely, not the block size but the number of accessed disks exerts an influence on performance. The number of disks to/from which I/O is made is estimated as the same number of stripe blocks straddled by an I/O, and its expected value is calculated.

A method for calculating the expected value of the number of stripe blocks straddled by an I/O is described. A stripe width (=a size of a stripe block) varies depending on used RAID. This embodiment assumes that the stripe width (=the size of a stripe block) and the disk block size are respectively 64[K bytes (KB)] and 0.5[KB]. The disk block size is a size of a basic unit of data stored on a disk. A block size of all I/Os is an integral multiple of the disk block size. Although a block size issued from a user (application program) is an arbitrary size, the block size is shaped to be an integral multiple of a disk block size in any system by a file system used by an operating system (OS). In this embodiment, since an average value of block sizes is used, the average value does not always become an integral multiple of a disk block size. However, the block size is larger than the value of the disk block size. This embodiment assumes that the average block size is an integral multiple of the disk block size for convenience of an explanation.

The average block size is denoted as “r” [KB]. When an offset (a starting address of an area to be accessed) of an I/O is a boundary of a stripe block, a block size M of the last stripe block to be accessed is represented by the following expression.

M=((r−0.5)mod 64)+0.5

Moreover, the smallest number of stripe blocks accessed by an I/O is represented by the following expression.

N=(r−M+64)/64

The expected value E of the number of stripe blocks straddled by an I/O is represented by the following expression.

E=(N+1)(2M−1)/128+N(128−2M+1)/128

The above described expected value is calculated respectively for each of the average block sizes of READ and WRITE.
Expected value (E_{R}) of the number of stripe blocks straddled by READ
Expected value (E_{W}) of the number of stripe blocks straddled by WRITE

Here, a case (Case 1 of FIG. 4B) where the offset of an I/O is exactly the same as the boundary of a stripe block is considered. Assume that a size of an access to the last stripe block accessed in this case is M. This is the case where the number of stripe blocks accessed by an I/O is the smallest.

A shift of the offset by a disk block size to a block immediately preceding the next boundary (Case 2 of FIG. 4B) from Case (1) is considered. Since the number of disk blocks within the stripe block is 128, the offset of the I/O are shifted to 128 positions in total. These states where the offset of the I/O is possibly shifted to the 128 positions are all the states for which the number of stripe blocks straddled by an I/O is to be considered.

Considering all of the above, it is proved that N=1 blocks are straddled at the maximum when the number of straddled blocks in Case (1) is assumed to be N. Accordingly, it is sufficient that the case where the number of straddled blocks is N and the case where the number of straddled blocks is N+1 are respectively counted among the 128 states.

The number of blocks from Case (1) up to the case (Case (3) of FIG. 4B) where the end of the I/O overlaps the boundary of a stripe block is N, the number of blocks from Case (3) to Case (2) is N+1. In Case (2), the size by which an access is made to the (N+1)th stripe block is M−0.5[KB]. By converting the size into the number of disk blocks, 2M−1 is obtained. Accordingly, a probability that the number of straddled blocks results in N+1 is (2M−1)/128, and a probability that the number of straddled blocks results in N is 1−((2M−1)/128)=(128−2M+1)/128. Values obtained by multiplying these probabilities respectively by the values (the number of straddled blocks) are added, so that an expected value of the number of straddled stripe blocks is obtained.

A response performance model is described next. An expression that predicts random access performance (READ response) in a certain RAID group is represented by the following expression (1). Parameters A, a, and E within the expression will be described later.

$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , {W}_{R} = α A ( {X}_{R} \leq \frac{ɛ}{α A} ) \qquad ( 1 )$$

Input information X_{R}: READ I/O frequency (IOPS)

Output information W_{R}: READ response [sec]

Parameter A: RAID coefficient

α: Disk coefficient

ε: Phase change multiplicity

It is assumed that a cache miss occurs by 100% in the case of READ and a cache hit occurs by 100% in the case of WRITE. Accordingly, by predicting a READ response, the entire response is predicted.

The RAID coefficient A is a value decided according to a RAID configuration of a RAID group regardless of a used disk. In the case of RAID5, the RAID coefficient (A) is represented by the following expression (2).

$$A = \frac{1}{2} \frac{R}{{E}_{R} - 0.25} \qquad ( 2 )$$

In the case of RAID6, the RAID coefficient (A) is represented by the following expression (2′).

$$A = \frac{2}{3} \frac{R}{{E}_{R} - 0.25} \qquad ( {2}^{′} )$$

where R and E_{R} respectively indicate a RAID rank, and an expected value of segment blocks straddled by a READ I/O. A value (½ or ⅔) of the coefficient A is decided according to a RAID level, and a value of a numerator is decided according to a RAID member (RAID rank). Therefore, it is possible to say that the RAID coefficient is decided according to a RAID configuration.

The disk coefficient (α) is a value decided according to disk characteristics of a used disk regardless of a RAID group. In the case of RAID5, the disk coefficient (α) is represented by the following expression (3).

$$α = \frac{{E}_{R} - 0.5}{R} D \sqrt{\frac{v + 0.5}{1.5}} \qquad ( 3 )$$

In the case of RAID6, the disk coefficient (α) is represented by the following expression (3′).

$$α = \frac{3}{4} \frac{{E}_{R} - 0.5}{R} D \sqrt{\frac{v + 0.5}{1.5}} \qquad ( {3}^{′} )$$

where R, E_{R}, D, and v are respectively a RAID rank, the expected value of the number of segment blocks straddled by a READ I/O, a disk constant (a constant value according to a type of a disk (the number of revolutions) regardless of RAID), and a ratio of an actually accessed area in a RAID group (0≦v≦1).

The disk constant (D) is a value decided according to disk characteristics such as the number of revolutions of a disk, and the like. However, since it is difficult to put the constant into a model for all disks, a measured value of a used disk is utilized.

Also the expression of the disk coefficient (α) includes a RAID rank. The RAID rank referred to here is a term derived from measurement results (to be described later) such that the minimum response of READ does not vary although a RAID level changes. The disk coefficient is set based on the disk characteristics regardless of a RAID configuration. The disk constant D indicates performance derived from a property of a disk, such as the number of revolutions, or the like. The term

$$\sqrt{\frac{v + 0.5}{1.5}}$$

is equivalent to a term for estimating disk an improvement of performance by a stochastic decrease in seek time due to a reduction in a used ratio. The seek time can be estimated with (L)^{1/2} with respect to a seek distance L.

The phase change multiplicity (ε) is described next. The phase change multiplicity ε is a value decided according to workload characteristics, and represented by the following calculation expression (4).

$$ɛ = \frac{c α A}{c α A + ( 1 - c ) V} \qquad ( 4 )$$

where α, A, c, and V are respectively a disk coefficient, a RAID coefficient, a READ ratio (a ratio of a READ I/O frequency to a total I/O frequency) (0≦c≦1), and a virtual WRITE cost (a value obtained by estimating an internal process cost of WRITE).

The virtual WRITE cost is a value that varies depending on the READ block size (E_{R}), the WRITE block size (E_{W}), and a ratio (v) of an accessed area. Therefore, it is very difficult to put the virtual WRITE cost into a model for a used workload. Accordingly, a limiting condition is set for a used workload, and a measured value of the limiting condition is used as the virtual WRITE cost. For example, v, E_{R}, and the READ block size respectively result in 1, E_{W}, and 8 [Kb], 16 [KB], 32 [KB], 48 [KB], and 64 [KB].

Since αA, V, and c respectively indicate the minimum response (to be described later) of READ, the virtual WRITE cost, and the READ ratio, it is possible to say that the value of the phase change multiplicity ε is decided according to workload characteristics.

A method for evaluating response performance is described next. When a user has a definite policy for a response, namely, when a RAID response needs to be a certain value or smaller in order to safely operate a system that uses RAID as storage, a response is directly evaluated based on the reference. For example, when commodity data is saved in this RAID and a commodity selling site on the Web is created, a user utilizing this commodity selling site might feel slow in some cases unless the response of RAID is, for example, no later than 0.010 [sec]. In this case, an I/O frequency is calculated based on an assumed number of accesses to the commodity selling site, and RAID is recognized to have sufficient performance when a calculated response based on the I/O frequency is, for example, no later than 0.010 [sec]. Alternatively, the entire commodity selling site is designed by inversely calculating an I/O frequency at which the response is, for example, no later than 10 [sec], and by inversely calculating also the number of accesses that enable the commodity selling site to be safely operated based on the I/O frequency.

In contrast, when the user does not have the definite policy for the response, a multiplicity is used as an indicator. The multiplicity is the same as a queue length of a command. Some system hardware have a limitation on a maximum value of the queue length. For example, in FCHBA (Fibre Channel Host Bus Adaptor) used to connect between a host and RAID, the maximum value of the queue length is limited to approximately 30 due to a limitation imposed on an internal memory space. When the multiplicity is equal to or less than the maximum value 30 of the queue length, the system is evaluated to be safely operable.

Details of the process for evaluating response performance in this embodiment are described next.

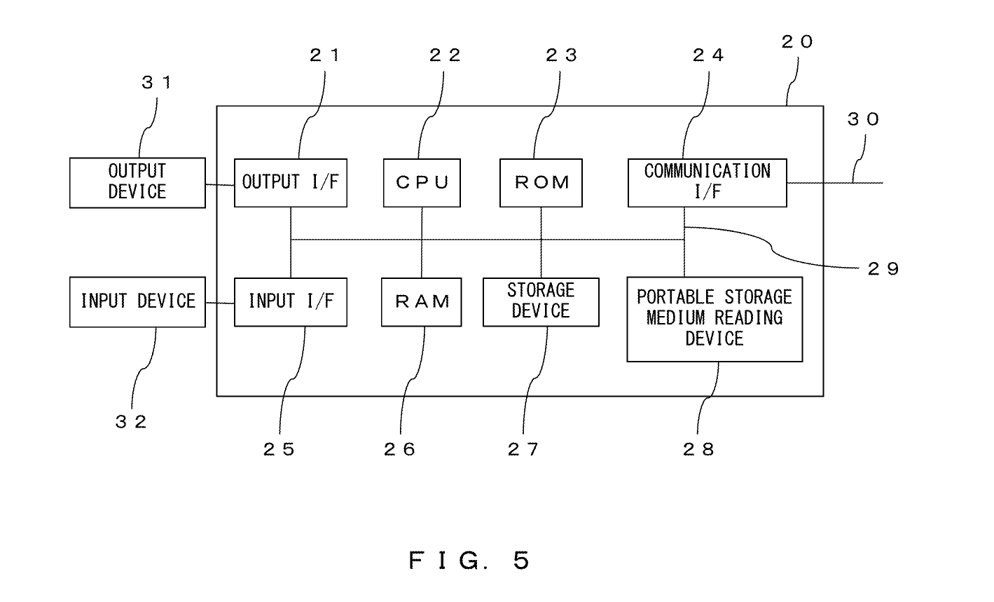

FIG. 5 is a block diagram illustrating hardware of a computer for executing the process for evaluating response performance in this embodiment. The computer 20 functions as a performance evaluation assistance apparatus by reading a program for executing processes of the embodiment.

The computer 20 includes an output I/F 21, the CPU 22, a ROM 23, a communication I/F 24, an input I/F 25, a RAM 26, a storage device 27, a reading device 28, and a bus 29. The computer 20 is connectable to an output device 31 and an input device 32.

Here, the CPU stands for a central processing unit. The ROM stands for a read-only memory. The RAM stands for a random access memory. The I/F stands for an interface. To the bus 29, the output I/F 21, the CPU 22, the ROM 23, the communication I/F 24, the input I/F 25, the RAM 26, the storage device 27, and the reading device 28 are connected. The reading device 28 is a device for reading a program and a data from a portable recording medium. The output device 31 is connected to the output I/F 21. The input device 32 is connected to the input I/F 25.

As the storage device 27, storage devices in various forms such as a hard disk drive, a flash memory device, a magnetic disk device, and the like are available.

In the storage device 27 or the ROM 23, a response performance evaluation assistance program for implementing processes to be described later, parameters used in the evaluation process, specified threshold values, and the like are stored.

The CPU 22 is one example of a processor, and reads and executes the response performance evaluation assistance program according to the embodiment, which is stored in the storage device 27 or the like.

The response performance evaluation assistance program according to this embodiment may be stored, for example, in the storage device 27 via a communication network 30 and the communication I/F 24 from a program provider side. Moreover, the program for implementing the processes described in first to third embodiments may be stored on a marketed and distributed portable storage medium. In this case, the portable storage medium may be set in the reading device 28, and the program stored on the storage medium may be read and executed by the CPU 22. As the portable storage medium, storage media in various forms such as a CD-ROM, a flexible disk, an optical disk, a magneto-optical disk, an IC (Integrated Circuit) card, a USB (Universal Serial Bus) memory device, and the like are available. The program stored on such storage media is read by the reading device 28.

Additionally, as the input device 32, a keyboard device, a mouse device, an electronic camera, a Web camera, a microphone, a scanner, a sensor, a tablet device, a touch panel device, or the like is available. As the output device 31, a display device, a printer, a speaker, or the like is available. Moreover, the network 30 may be a communication network such as the Internet, a LAN, a WAN, a dedicated line network, a wired network, a wireless network, or the like.

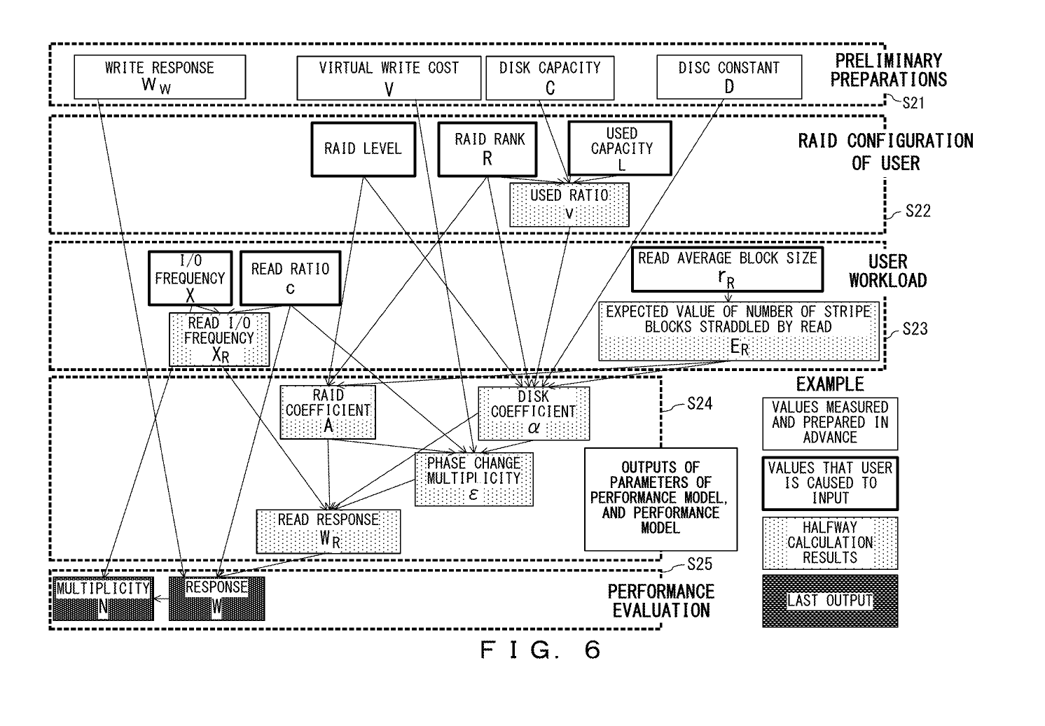

FIG. 6 is a flowchart illustrating the process for evaluating response performance in this embodiment. Preliminary preparations (S21) are initially described. Here, the disk capacity (C) is assumed to be obtained in advance. The disk constant (D) of a used disk is obtained with a measurement. Moreover, the virtual WRITE cost (V) in a limited workload pattern to be used is obtained with a measurement. With WRITE, a cache hit occurs by 100%. A response (W_{W}) (a value always constant in any situation) in this case is obtained with a measurement. The disk capacity (C), the disk constant (D), the WRITE response (W_{W}), and the virtual WRITE cost (V) are pre-registered to the storage device 27 of the computer 20 that evaluates response performance.

Next, the computer 20 obtains a RAID configuration and a volume configuration of storage used by a user (S22). The user inputs a RAID level, a RAID rank (R), and a used capacity (L) of a disk by using the input device 32. The computer 20 calculates a used ratio (v) (L=/(CR)) based on the disk capacity (C), the RAID rank (R), and the used capacity (L).

The computer 20 obtains workload characteristics of the storage used by the user (S23). The user inputs a total I/O frequency (X), a READ ratio (c), and a READ average block size (r_{R}) by using the input device 32. The computer 20 calculates the expected value (E_{R}) of the number of stripe blocks straddled by READ based on the READ average block size (r_{R}). Moreover, the computer 20 calculates the READ I/O frequency (X_{R}) based on the total I/O frequency (X) and the READ ratio (c).

Next, the computer 20 calculates parameters of a performance model, and outputs the performance model by using the parameters (S24). The computer 20 calculates a RAID coefficient (A) based on the RAID level, the RAID rank (R), and the expected value (E_{R}) of the number of stripe blocks straddled by READ. Moreover, the computer 20 calculates a disk coefficient (α) based on the RAID level, the RAID rank (R), the disk constant (D), and the used ratio (v). Additionally, the computer 20 calculates a phase change multiplicity (ε) based on the RAID coefficient (A), the disk coefficient (α), the virtual WRITE cost (V), and the READ ratio (ε). The computer 20 further calculates a READ response (W_{R}) based on the RAID coefficient (A), the disk coefficient (α), the phase change multiplicity (ε), and the READ I/O frequency (X_{R}).

The computer 20 calculates a response and a multiplicity of the storage by using the READ response (W_{R}) obtained with the performance model (S25). Specifically, the computer 20 calculates the response (W) with the following expression (5) by using the WRITE response (W_{W}), the READ ratio (c), and the READ response (W_{R}).

response(W)=cW_{R}+(1−c)W_{W} (5)

The computer 20 calculates the multiplicity (N) by using the following expression (6) based on the I/O frequency (X) and the response (W).

multiplicity(N)=XW (6)

The computer 20 outputs the response (W) and the multiplicity (N). The user evaluates the response performance of the target storage by using the output response (w) and multiplicity (N).

An implementation example of the flow illustrated in FIG. 6 is provided below. The following implementation example adopts a RAID performance prediction tool (service), which is one example of the performance evaluation assistance program according to this embodiment.

In S21, preliminary preparations for setting conditional information used by the performance evaluation assistance program are made to evaluate the performance of certain RAID. It is assumed that types of disks (Online SAS/Nearline SAS, a disk size, the number of revolutions, a capacity) that can be mounted in the RAID are as follows. Here, SAS stands for Serial Attached SCSI (Small Computer System Interface).
Online SAS 3.5 [inch] 15,000 [rpm] 300 [GB], 450 [GB], 600 [GB]
Online SAS 2.5 [inch] 15,000 [rpm] 300 [GB], 450 [GB], 600 [GB]
Online SAS 2.5 [inch] 10,000 [rpm] 300 [GB], 450 [GB], 600 [GB]
Nearline SAS 3.5 [inch] 7.200 [rpm] 1 [TB], 2 [TB], 3 [TB]
Nearline SAS 2.5 [inch] 7.200 [rpm] 1 [TB]

Since the type of the number of revolutions of the disks is three, a disk constant is measured for each of the disks.
disk constant of a disk of 15,000 [rpm](D₁)=0.017
disk constant of a disk of 10,000 [rpm](D₂)=0.021
disk constant of a disk of 7,200 [rpm](D₃)=0.037

Although a size (2.5 [inch] or 3.5 [inch]) or a capacity of the disks changes, performance does not vary. Therefore, the performance evaluation assistance program supports all the disks listed with the above described three types of disk constants. However, when the time of manufacturing a disk or the generation of a disk differs, a firmware control or a disk component is possibly different although the number of revolutions, a disk size and a capacity are the same. Therefore, the performances possibly differ in some cases. Accordingly, assume that all the above described three disks are of the same generation.

Next, a workload supported by the performance evaluation assistance program is limited, namely, a limiting condition is set. This embodiment supports not a sequential access but a random access. Assume a condition that a type of an access is a random access, a cache miss occurs by 100% when a READ process is executed, and a cache hit occurs by 100% when a WRITE process is executed. This is the condition under which the performance of RAID is the worst in normal operations. Therefore, such a limitation is considered to have significance in a performance evaluation.

Further assume that an average READ block size and an average WRITE block size are the same.

As representative values of the average block size, for example, 8 [KB], 16[KB], 32[KB], and 64 [KB] are cited, and a user is caused to select a value closest to any of these representative values.

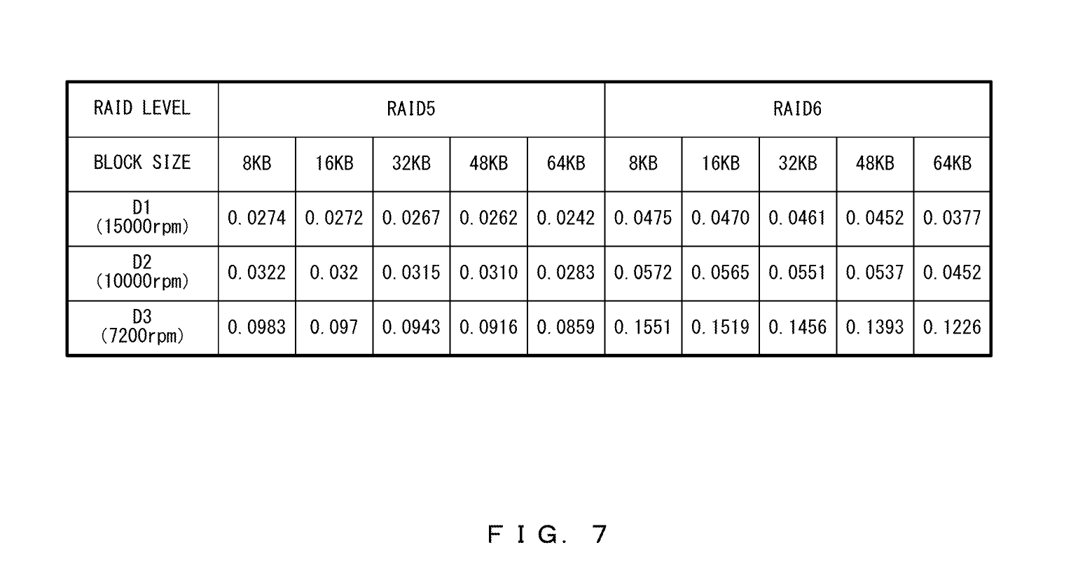

The virtual WRITE cost (V) corresponding to the above described limiting condition is measured. FIG. 7 illustrates measurement results of the virtual WRITE cost (V) for each of the RAID levels and each of the block sizes of the above described three disks.

At this time, also the WRITE response (W_{W}) is measured. Since the WRITE process assumes that a cache hit occurs by 100%, values of the WRITE response are expected to be almost the same value in all cases. This embodiment assumes that the WRITE response (W_{W}) is 0.000275 [sec].

S22 and S23 are described next. In S22 and S23, the user inputs RAID configuration information of a used disk (attribute information, information of a RAID level, information of a RAID member, and information of a used capacity), workload information (an I/O frequency, a READ ratio, and an average block size) to the performance evaluation assistance program. For example, a case where the user inputs the following information is considered.

RAID5 (4+1) is created by using the disk of 2.5 [inch], 10,000 [rpm], and SAS 600 [GB].
All areas in the above described RAID are used.
An access (load) that the user makes to the RAID is 300 [IOPS].
The READ ratio is 75%, and the average block size is 48 [KB].

The computer 20 selects suitable conditional values from among prepared conditional values based on the above described inputs, and calculates input parameters used for the performance model.
Disk constant: D=0.021
Virtual WRITE cost: v=0.0310
WRITE response: W_{W}=0.00275
RAID rank: R=4
Used ratio: v=1
I/O frequency: X=1000
READ ratio: c=0.75
READ I/O frequency: X_{R}=cX=0.75×300=225
Average block size: r=48 [KB]

The expected value E of the number of stripe blocks straddled by an I/O is obtained.
M=((r−0.5)mod 64)+0.5=48
N=(r−M+64)/64=1
E=(N+1) (2M−1)/128+N(128−2M+1)/128=1.7422

Since the average block size and the READ average block size are the same, the expected value E_{R} of the number of stripe blocks straddled by READ becomes equal to the expected value E of the number of stripe blocks straddled by the I/O.

S24 is described next. In S24, the computer 20 calculates the parameters used in the performance model based on the inputs to the performance prediction tool. Since the RAID level is RAID5, the computer 20 calculates the RAID coefficient A by using the above provided expression (2).

$$A = \frac{1}{2} \frac{R}{{E}_{R} - 0.25} = \frac{1}{2} \frac{4}{1.7422 - 0.25} = 1.34$$

Since the RAID level is RAID5, the computer 20 calculates the disk coefficient α by using the above provided expression (3).

$$α = \frac{{E}_{R} - 0.5}{R} D \sqrt{\frac{v + 0.5}{1.5}} = \frac{1.7422 - 0.5}{4} \times 0.021 \times \sqrt{\frac{1 + 0.5}{1.5}} = 0.00652$$

The computer 20 calculates the phase change multiplicity ε by using the above provided expression (4). Here, for ease of the calculation, αA=0.00874 is calculated in advance.

$$ɛ = \frac{c α A}{c α A + ( 1 - c ) V} = \frac{0.75 \times 0.00874}{( 0.75 \times 0.00874 ) + ( 0.25 \times 0.0310 )} = 0.458$$

The computer 20 calculates the READ response W_{R} by using the performance model represented by the above provided expression (1).

$${W}_{R} = \frac{ɛ A ( {e}^{\frac{α}{ɛ} ( {X}_{R} - \frac{ɛ}{α A} )} - 1 ) + ɛ}{{X}_{R}} = \frac{0.458 \times 1.34 \times ( exp ( \frac{0.00652}{0.458} \times ( 255 - \frac{0.458}{0.00874} ) ) - 1 ) + 0.458}{225} = 0.0291$$

In this way, the predicted value of the READ response 0.0291 [sec] is obtained.

S25 is described next. In S25, a response and a multiplicity are calculated based on the READ response, and the performance is evaluated. The computer 20 calculates the response W by using the above provided expression (5).

W=cW_{R}+(1−c)W_{W}=0.75×0.0291+0.25×0.000275=0.0219

Accordingly, the response is proved to be 0.0219 [sec].

The computer 20 calculates the multiplicity (N) by using the above provided expression (6).

N=XW=300×0.0219=6.57

Then, the computer 20 displays the response (W) and the multiplicity (N) as outputs of the performance prediction tool (service).

The user is able to evaluate the performance based on the response of 0.0219 [sec] or the multiplicity of 6.57 before the user actually uses RAID or while using RAID in real time. As a result, for example, when the response time is longer than a system reference, the user is able to take measures such as changing to a configuration of higher performance.

A logical analysis of a performance model is described next.

Here, the performance model is logically analyzed. Derivation of the performance model in the case of only READ is initially described. The multiplicity (N) is represented as an expression obtained with an exponential function (y=Ae^{Bx}+β) to which a non-linear term is added.

N=Ae^{BX}+β X:I/O frequency

Little's formula (multiplicity=I/O frequency×response [sec]) is substituted into this expression.

response(W)=(Ae^{BX}+β)/X

However, X diverges to infinity at the limit of 0 in the above provided expression. Namely,

$$lim {X}_{x -> 0} = 0$$

$$in$$

$${lim}_{X -> 0} A {e}^{BX} + β = A + β$$

$$Therefore , \\ lim {W}_{x -> 0} = ∞$$

To solve this problem, it is assumed that an I/O is only READ, and the state of the above provided expression of the response (W) differs at a boundary of the multiplicity 1. Here, a cache hit occurs by 100% when WRITE is made, and the response is almost 0 [sec]. Therefore, the case of only READ is tentatively considered.

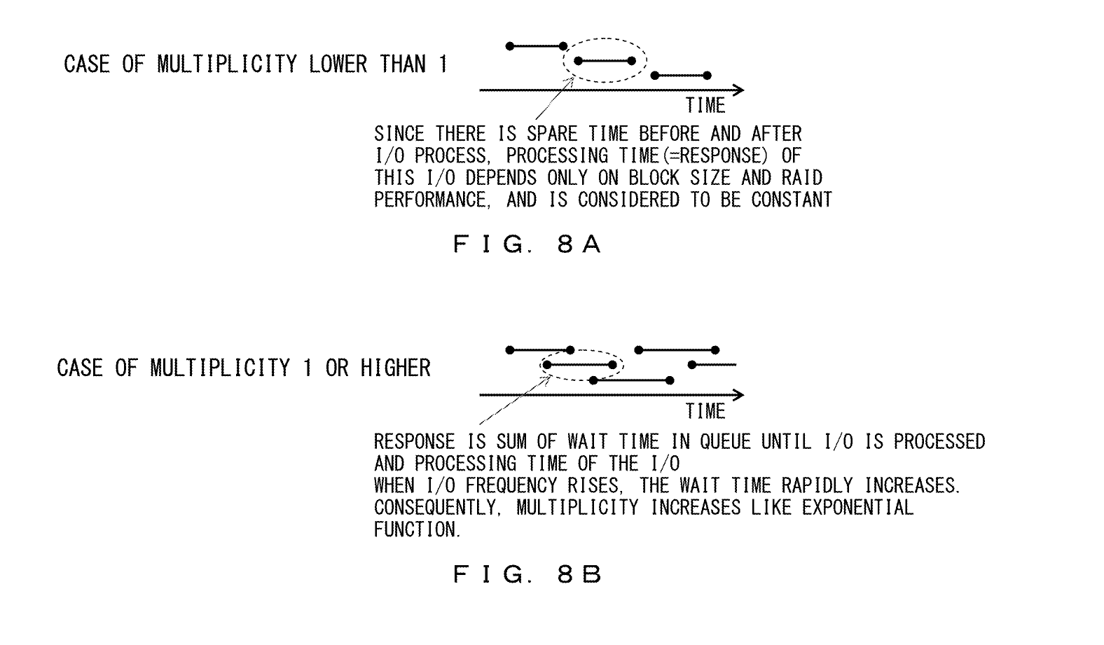

FIGS. 8A and 8B are explanatory diagrams of the multiplicity in this embodiment. When the multiplicity is equal to or lower than 1, I/Os are processed without overlapping as illustrated in FIG. 8A. Accordingly, when block sizes are the same, responses of the I/Os are considered to be constant regardless of an I/O frequency and a multiplicity.

When the multiplicity is equal to or higher than 1, the I/Os overlap as illustrated in FIG. 8B. Since the I/Os overlap in this case, a time waiting to be processed occurs only because the I/Os are linked to a queue. This “time waiting to be processed” is expected to increase the multiplicity like an exponential function with respect to an I/O frequency.

Accordingly, the response W is considered to be constant up to the multiplicity 1, and to increase like an exponential function at the multiplicity 1 or higher.

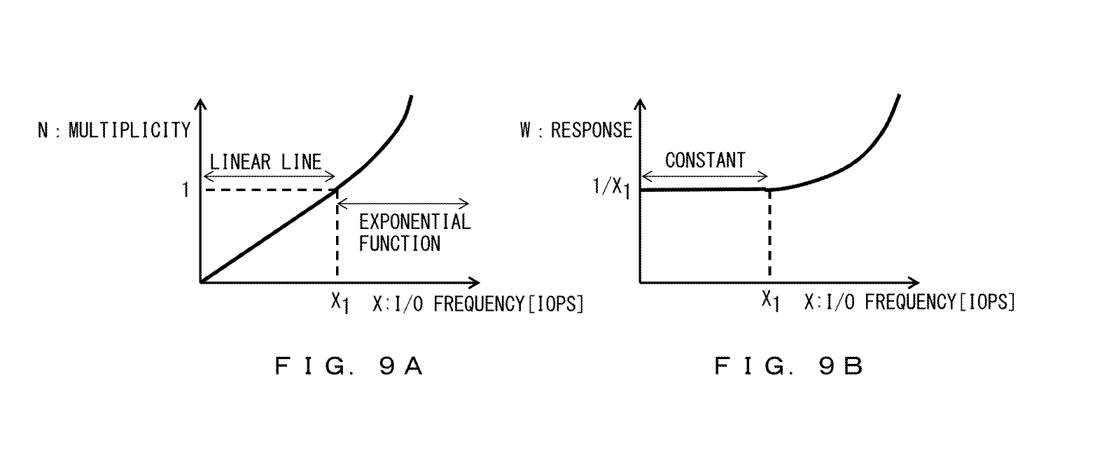

FIGS. 9A and 9B are explanatory diagrams of derivation of a performance model in the case of only READ in this embodiment. A state transition at the multiplicity is incorporated in a mathematical expression of the performance model, so that the following expression is obtained. A transition from a state where a response is constant at the multiplicity lower than 1 to a state where a response increases like an exponential function at the multiplicity 1 or higher as illustrated in FIG. 9A is captured as a phase change, and the multiplicity 1 is referred to as “a phase change multiplicity in the case of only READ”.

$$W = \frac{A ( {e}^{α ( X - {X}_{1} )} - 1 ) + 1}{X} ( X \geq {X}_{1} ) , \\ W = \frac{1}{{X}_{1}} ( X \leq {X}_{1} )$$

where X₁ is a READ I/O frequency at which the multiplicity of READ is 1.

Since the READ I/O frequency is X₁ when the READ multiplicity is 1, a response in this case is 1/X₁ based on Little's formula. When the I/O frequency is equal to or lower than X₁, the response is 1/X₁ as illustrated in FIG. 9B. Therefore, 1/X₁ is referred to as a minimum response.

The expression N=Ae^{αX}+β results in N=A+β in the case of X=0. When an affine transformation (parallel shift) is performed to obtain N=1 in the case of X=X₁, N=A(e^{α(X-X1)}−1)+1. On the right side of this expression, “−1” is a constant that cancels an exponential term in the case of X=X₁, whereas “+1” indicates a multiplicity in the case of X=X₁. By converting this expression of the multiplicity based on Little's formula, the above described performance model is obtained.

Additionally, a smoothness condition that slopes of the multiplicity with respect to the I/O frequency are the same before and after the multiplicity 1 is taken into account for the performance model. This smoothness condition supposes that the multiplicity does not rapidly increase at the border of the multiplicity but naturally and moderately increases when the I/O frequency is gradually increased from the multiplicity lower than 1.

Accordingly, the performance model is differentiated with respect to the I/O frequency (X) before and after the multiplicity 1, and resultant values are assumed to be the same.

$${lim}_{X \to {X}_{1} -} \frac{d }{d X} N = {lim}_{X \to {X}_{1} -} \frac{d }{d X} \frac{X}{{X}_{1}} = {lim}_{X \to {X}_{1} -} \frac{1}{{X}_{1}} = \frac{1}{{X}_{1}}$$

$${lim}_{X \to {X}_{1} +} \frac{d }{d X} N = {lim}_{X \to {X}_{1} +} \frac{d }{d X} \{ A ( {e}^{α ( X - {X}_{1} )} - 1 ) + 1 \} = {lim}_{X \to {X}_{1} +} α A {e}^{α ( X - {X}_{1} )} = α A$$

Accordingly, X₁=1/(αA) is obtained by supposing the smoothness condition. Here, since the exponential function is a monotonically increasing function, the response W=1/X₁=αA in the case where the I/O frequency is equal to or lower than X₁ results in a minimum response.

In this way, the performance model in the case of only READ is obtained as represented by the following expression (1′).

$$W = \frac{A ( {e}^{α ( X - \frac{1}{α A} )} - 1 ) + 1}{X} ( X \geq \frac{1}{α A} ) , \\ W = α A ( X \leq \frac{1}{α A} ) \qquad ( {1}^{′} )$$

At this time, the phase change multiplicity ε is 1 in the case of only READ (c=1), and the above provided expression (1′) is the same as an expression obtained by substituting ε=1 into the expression of the performance model.

As a result of repeatedly measuring the performance of various RAID configurations in the case of only READ when the coefficients are put into a model, the following findings are obtained. The followings are findings obtained by measuring the performance in a frequently used block size range (8 [KB] to 64 [KB]).

Constant coefficient A for the exponential function:
Constant coefficient A has the same value although a disk or a used ratio changes.
Constant coefficient A is proportional to a RAID rank.
Constant coefficient A exhibits a property nonlinearly inverse proportional to an expected value of the number of stripe blocks straddled by an I/O, and a value of the nonlinear term is constant (0.25) regardless of a RAID level.

Exponential coefficient α for the exponential function:
Exponential coefficient α is inverse proportional to a RAID rank.
Exponential coefficient α exhibits a property, provided with an intercept, proportional to an expected value of the number of stripe blocks straddled by an I/O, and the x intercept is constant regardless of a RAID level.
Exponential coefficient α is proportional to a value obtained by taking the square root of a used ratio.

Minimum response αA:
Minimum response αA is constant regardless of a RAID level and a RAID rank.

Accordingly, the constant coefficient A and the exponential coefficient α are named as a RAID coefficient and a disk coefficient, and put into a model, so that the expressions (2) and (2′), and (3) and (3′) are obtained. Here, both RAID5 and RAID 6 result in

$$α A = \frac{1}{2} \frac{{E}_{R} - 0.5}{{E}_{R} - 0.25} D \sqrt{\frac{v + 0.5}{1.5}}$$

This value is irrelevant to a RAID configuration.

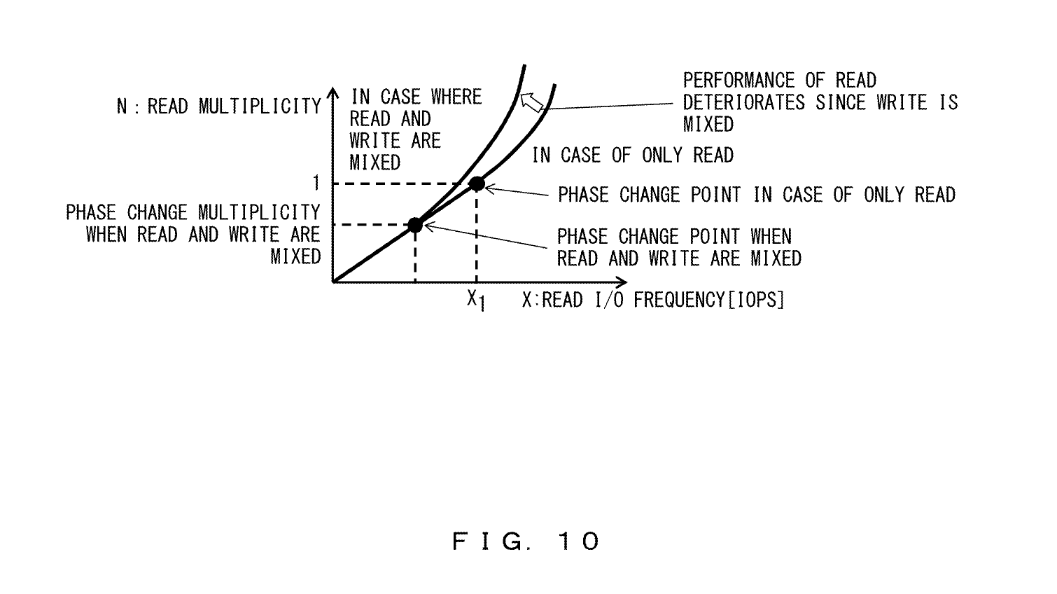

A performance model when READ and WRITE are mixed is described next with reference to FIG. 10. A case of only a READ access or a WRITE access is a special case. Normally, mixed accesses of READ and WRITE are made.

At the time of a WRITE process, a response takes almost 0 [sec] since a cache hit occurs by 100%. However, as illustrated in FIG. 10, performance of READ normally deteriorates as a ratio of WRITEs increases. An influence that the process of the WRITE command exerts on performance does not directly appear in a response of WRITE, but indirectly appears as deterioration of a response of READ. It is very difficult to quantify this influence. Accordingly, assume that the phase change multiplicity becomes a value smaller than 1 due to mixing with WRITE, leading to deterioration a READ response.

Estimation of the phase change multiplicity when READ and WRITE are mixed is considered below. The findings of measurement results are obtained such that the minimum response of the READ response is constant regardless of a WRITE ratio. Accordingly, the case where the phase change multiplicity is equal to or lower than 1, READ response W_{R}=αA is assumed.

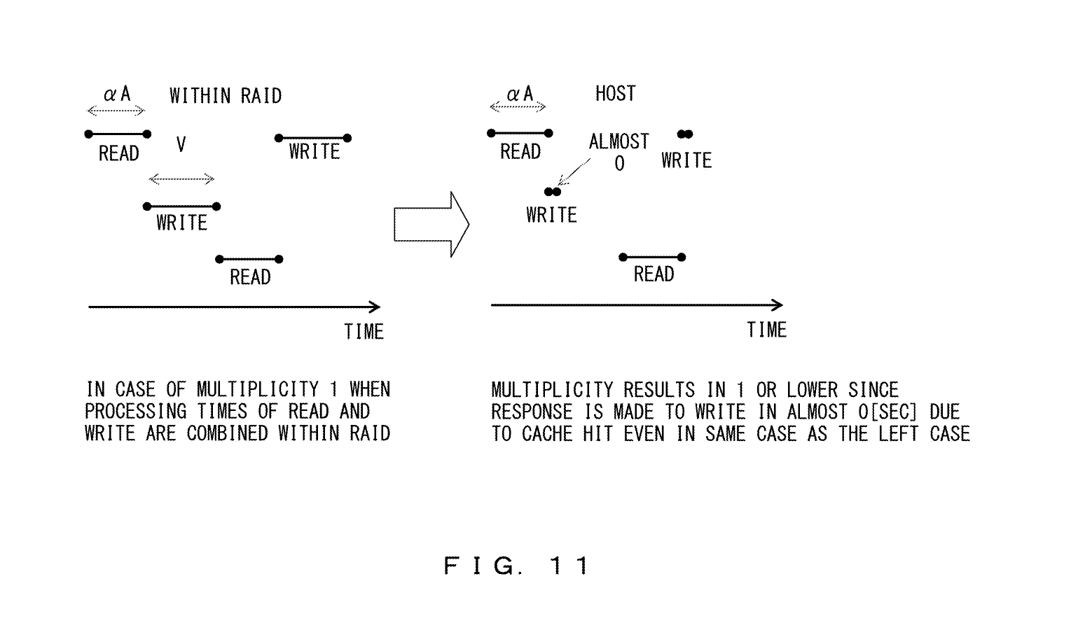

Normally, the process of the WRITE command is more complex than that of the READ command. Therefore, the amount of time needed for the process of the WRITE command is longer than that needed for the process of the READ command. For example, when the WRITE command is obtained, storage executes internal processes for reading a parity corresponding to WRITE data, for calculating a new parity, and for writing the WRITE data and the new parity to disks. However, the amount of time of the internal processes cannot be measured from a host as illustrated in FIG. 11 since a cache hit occurs by 100% when WRITE is made. Accordingly, the amount of time of the internal processes needed for each WRITE command is assumed to be a virtual WRITE cost V. Moreover, as illustrated in FIG. 11, the point where the multiplicity is 1 when READ and WRITE are combined within RAID is assumed to be a phase change point.

An I/O frequency at which the multiplicity when READ and WRITE are combined is 1 within RAID in the case of READ ratio c (0<c<1) is assumed to be X_{c}. As illustrated in FIG. 11, the READ response W_{RC}=WR=αA. The read multiplicity ε is

ε=X_{RC}W_{RC}=cαAX_{c} (7)

based on Little's formula. Since the multiplicity is 1 within RAID, Little's formula is applied within the RAID.
N=X_{RC}W_{RC}+X_{WC}W_{WC}
WRITE I/O frequency: X_{Wc}=(1-c)X₀
WRITE response: W_{Wc}=V (WRITE virtual cost)
1=cαAX_{c}+(1−c)VX_{c}=(cαA+(1−c)V)X_{c}
Xc=1/(cαA+(1−c)V)
   Thus obtained X_{c} is substituted into the READ multiplicity represented by the expression (7).

ε=cαA/(cαA+(1−c)V)

This READ multiplicity is assumed to be a phase change multiplicity, and applied to a performance model expression, which is a READ response prediction expression.

An application of the phase change multiplicity when READ and WRITE are mixed to a performance model is considered below. At the READ ratio c, the READ multiplicity ε is the phase change multiplicity. A RAID coefficient and a disk coefficient in this case are respectively assumed to be A′ and α′. An approximation of an exponential function including a nonlinear term for the multiplicity is considered similarly to the case of only READ. When the READ I/O frequency is assumed to be X_{R}, the exponential function expression including the nonlinear term for the READ multiplicity is created similarly to the case of only READ since the phase change multiplicity is ε. A READ I/O frequency at which the READ frequency is ε is assumed to be X₁′ when the READ ratio is c.

$${N}_{R} = {A}^{′} ( {e}^{{α}^{′} ( {X}_{R} - {X}_{1}^{′} )} - 1 ) + ɛ ( {X}_{R} \geq {X}_{1}^{′} ) , \\ {N}_{R} = ɛ \frac{{X}_{R}}{{X}_{{1}^{′}}} ( {X}_{R} \leq {X}_{1}^{′} )$$

A smoothness condition at the point of the READ multiplicity ε is applied similarly to the case of only READ.

$${lim}_{{X}_{R} \to {X}_{1}^{′} -} \frac{d}{d X} {N}_{R} = \frac{ɛ}{{X}_{{1}^{′}}} , \\ {lim}_{{X}_{R} \to {X}_{1}^{′} +} \frac{d }{d X} {N}_{R} = {α}^{′} {A}^{′}$$

As a result, X₁′=ε/(α′A′).

From the standpoint such that the minimum response is constant regardless of the READ ratio, α′A=αA.

The performance model results in the expression (1″).

$${W}_{R} = \frac{{A}^{′} ( {e}^{{α}^{′} ( {X}_{R} - \frac{ɛ}{α A} )} - 1 ) + ɛ}{{X}_{R}} ( {X}_{R} \geq \frac{ɛ}{α A} ) , \\ {W}_{R} = α A ( {X}_{R} \leq \frac{ɛ}{α A} ) \qquad ( {1}^{″} )$$

where A and α are a RAID coefficient and disk coefficient in the case of only READ, and A′ and α′ are a RAID coefficient and a disk coefficient in the case where the READ ratio is c.

Values of A′ and α′ are obtained by assigning an actually measured value of performance to the above provided expression (1″), the following results are obtained.
A′=εA
α′=α/ε
   Consequently, αA=A′α′, which matches the findings such that the minimum response does not vary at any READ ratio.

In this way, the expression (1) of the performance model is derived.

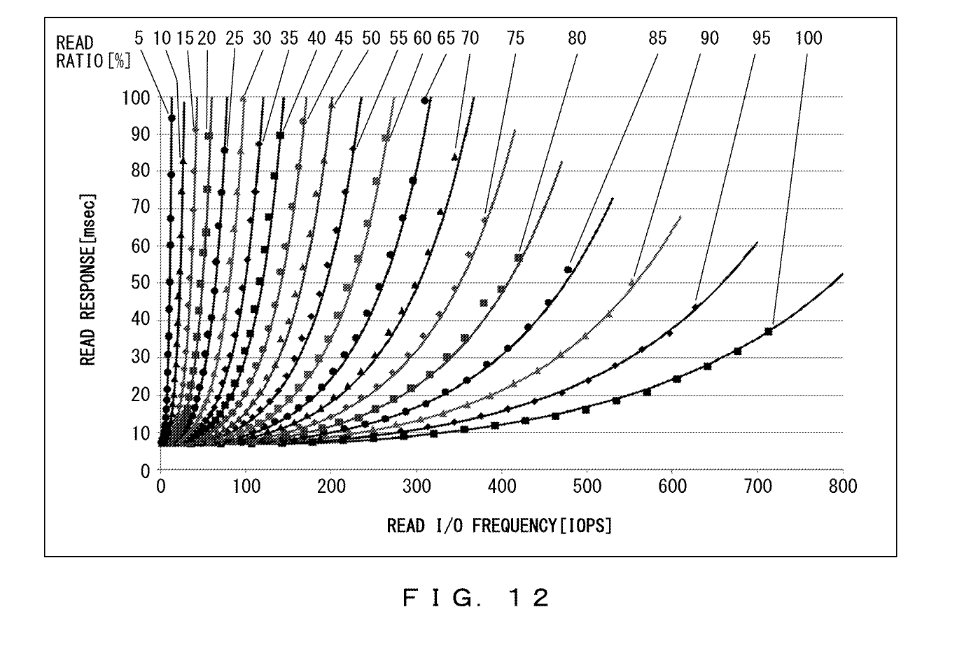

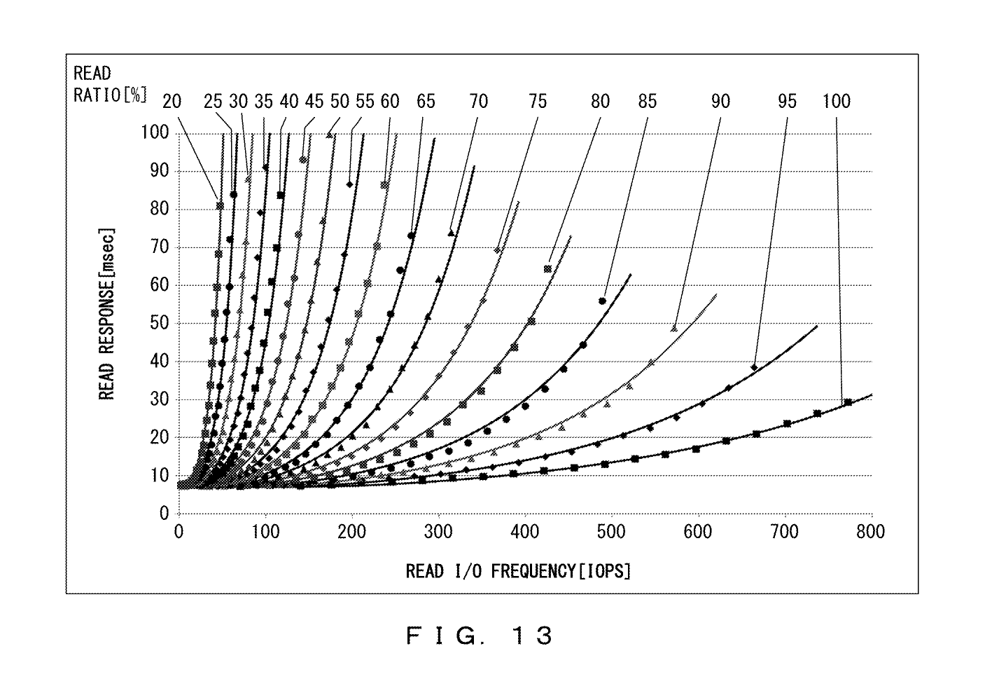

FIG. 12 illustrates actually measured values and predictions of performance of an Online SAS disk RAID5 (4+1) in this embodiment. FIG. 13 illustrates actually measured values and predictions of performance of an Online SAS disk RAID6 (4+2) in this embodiment. In FIGS. 12 and 13, horizontal and vertical axes respectively represent a READ I/O frequency and a READ response [sec]. These figures illustrate the actually measured values when the I/O frequency is gradually increased in a case where the READ ratio is decremented from 100% by 5%. Here, a solid line indicates a predicted value for each READ ratio, whereas a dot indicates an actually measured value. As illustrated in FIGS. 12 and 13, it is proved that the actually measured values and the predictions of performance are close to each other and both the actually measured values and the predictions are predicted with high accuracy.

According to this embodiment, a change of a multiplicity with respect to a load (I/O frequency) is put into a model with an exponential function including a nonlinear term, whereby highly accurate performance (response) prediction is implemented. The expressions used here are the exponential function and Little's formula. In addition to these expressions, a highly accurate performance model expression is generated by assuming that performance falls into a low load phase (state where the multiplicity is equal to or lower than a phase change multiplicity) and a high load phase (state where the multiplicity is equal to or higher than the phase change multiplicity), and by assuming a smoothness condition for the phase change point.

Not internal devices within RAID and firmware but statistical characteristics indicated by a multiplicity and a response are put into a model, whereby universal and highly accurate performance prediction is implemented. Moreover, a small number of parameters are measured not only for the newest RAID but for an old or unknown RAID, whereby highly accurate performance prediction is performed.

One aspect of the present invention improves prediction accuracy of response performance.

The present invention is not limited to the above described embodiments, and may take various configurations or embodiments within a scope that does not depart from the gist of the present invention.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process for evaluating performance of a storage apparatus, the process comprising:
obtaining redundancy method information about a data redundancy method in a storage apparatus, the number of storage devices included in the storage apparatus, a used ratio indicating a ratio of a used storage area within a storage area of the storage device, a ratio of read requests to requests including read and write requests, an average data amount of data read in response to a read request, an input/output indicator indicating the number of requests issued per unit time, a constant indicating a processing time needed for a write request in the storage apparatus, and a storage device constant decided according to a type of the storage device;
calculating a redundancy coefficient indicating a characteristic amount for the data redundancy method of the storage apparatus by using the redundancy method information, the number of storage devices, and the average data amount;
calculating a storage device coefficient indicating a characteristic amount for performance of the storage device by using the redundancy method information, the number of storage devices, the average data amount, the used ratio, and the storage device constant;
calculating a phase change multiplicity indicating a multiplicity, which is a boundary between a low load phase where a response time is constant with respect to the input/output indicator and a high load phase where a multiplicity indicating the number of overlapping read or write requests from or to the storage apparatus per unit time increases with respect to the input/output indicator by using the storage device coefficient, the redundancy coefficient, the ratio of read requests, and the constant indicating the processing time;
calculating a read request indicator indicating the number of read requests issued per unit time by using the ratio of read requests and the input/output indicator issued per unit time; and
calculating a predicted value of an average response time to the read request by using the redundancy coefficient, the storage device coefficient, the phase change multiplicity, and the read request indicator.

2. The computer-readable recording medium according to claim 1, wherein
the predicted value W_{R} of the average response time to the read request is calculated by using the redundancy coefficient, the storage device coefficient, the phase change multiplicity, the read request indicator, and an expression
$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , \\ {W}_{R} = α A ( {X}_{R} \leq \frac{ɛ}{α A} ) \qquad ( 1 )$$
where A, α, ε, and X_{R} are respectively a redundancy coefficient, a storage device coefficient, a phase change multiplicity, and the number of read requests issued per unit time.

3. The computer-readable recording medium according to claim 1, the process further comprising:
obtaining a response time to a write request;
calculating a predicted value of an average response time to a request issued to the storage apparatus by using the ratio of read requests, the predicted value of the average response time to the read request, and the response time to the write request; and
calculating a multiplicity indicating the number of overlapping read or write requests from or to the storage apparatus per unit time by multiplying the predicted value of the average response time to the request by the input/output indicator.

4. The computer-readable recording medium according to claim 1, wherein
the calculating the redundancy coefficient and the calculating the storage device coefficient convert the average data amount read from the storage device included in the storage apparatus into an expected value of the number of storage devices to/from which data is written/read in response to a read request or the write request at the time of the read request, and calculate the redundancy coefficient and the storage device coefficient by using the expected value.

5. A performance evaluation assistance apparatus for evaluating performance of a storage apparatus, the performance evaluation assistance apparatus comprising:
a memory;
a processor configured to execute a process including
obtaining redundancy method information about a data redundancy method in a storage apparatus, the number of storage devices included in the storage apparatus, a used ratio indicating a ratio of a used storage area within a storage area of the storage device, a ratio of read requests to requests including read and write requests, an average data amount of data read in response to a read request, an input/output indicator indicating the number of requests issued per unit time, a constant indicating a processing time needed for a write request in the storage apparatus, and a storage device constant decided according to a type of the storage device;
calculating a redundancy coefficient indicating a characteristic amount for the data redundancy method of the storage apparatus by using the redundancy method information, the number of storage devices, and the average data amount;
calculating a storage device coefficient indicating a characteristic amount for performance of the storage device by using the redundancy method information, the number of storage devices, the average data amount, the used ratio, and the storage device constant;
calculating a phase change multiplicity indicating a multiplicity, which is a boundary between a low load phase where a response time is constant with respect to the input/output indicator and a high load phase where a multiplicity indicating the number of overlapping read or write requests from or to the storage apparatus per unit time increases with respect to the input/output indicator by using the storage device coefficient, the redundancy coefficient, the ratio of read requests, and the constant indicating the processing time;
calculating a read request indicator indicating the number of read requests issued per unit time by using the ratio of read requests and the input/output indicator issued per unit time; and
calculating a predicted value W_{R} of an average response time to the read request by using the redundancy coefficient, the storage device coefficient, the phase change multiplicity, and the read request indicator.

6. The performance evaluation assistance apparatus according to claim 5,
the calculating the predicted value W_{R} calculates the predicted value W_{R} of the average response time to the read request by using the redundancy coefficient, the storage device coefficient, the phase change multiplicity, the read request indicator, and an expression
$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , \\ {W}_{R} = α A ( {X}_{R} \leq \frac{ɛ}{α A} ) \qquad ( 1 )$$
where A, α, ε, and X_{R} are respectively a redundancy coefficient, a storage device coefficient, a phase change multiplicity, and the number of read requests issued per unit time.

7. The performance evaluation assistance apparatus according to claim 5, wherein:
the obtaining further obtains a response time to a write request; and
the process further comprises
calculating a predicted value of an average response time to a request issued to the storage apparatus by using the ratio of read requests, the predicted value of the average response time to the read request, and the response time to the write request, and
calculating a multiplicity indicating the number of overlapping read or write requests from or to the storage apparatus per unit time by multiplying the predicted value of the average response time to the request by the input/output indicator.

8. The performance evaluation assistance apparatus according to claim 5, the process further comprising
converting the average data amount read from the storage device included in the storage apparatus into an expected value of the number of storage devices to/from which data is written/read in response to a read request or the write request at the time of the read request, wherein
the calculating the redundancy coefficient and the calculating the storage device coefficient calculate the redundancy coefficient and the storage device coefficient by using the expected value.

9. A performance evaluation assistance method of a storage apparatus, which is executed by a computer, the performance evaluation assistance method comprising:
obtaining, by the computer, redundancy method information about a data redundancy method in the storage apparatus, the number of storage devices included in the storage apparatus, a used ratio indicating a ratio of a used storage area within a storage area of the storage device, a ratio of read requests to requests including read and write requests, an average data amount of data read in response to a read request, an input/output indicator indicating the number of requests issued per unit time, a constant indicating a processing time needed for a write request in the storage apparatus, and a storage device constant decided according to a type of the storage device;
calculating, by the computer, a redundancy coefficient indicating a characteristic amount for the data redundancy method of the storage apparatus by using the redundancy method information, the number of storage devices, and the average data amount;
calculating, by the computer, a storage device coefficient indicating a characteristic amount for performance of the storage device by using the redundancy method information, the number of storage devices, the average data amount, the used ratio, and the storage device constant;
calculating, by the computer, a phase change multiplicity indicating a multiplicity, which is a boundary between a low load phase where a response time is constant with respect to the input/output indicator and a high load phase where a multiplicity indicating the number of overlapping read or write requests from or to the storage apparatus per unit time increases with respect to the input/output indicator by using the storage device coefficient, the redundancy coefficient, the ratio of read requests, and the constant indicating the processing time;
calculating, by the computer, a read request indicator indicating the number of read requests issued per unit time by using the ratio of read requests and the input/output indicator issued per unit time; and
calculating, by the computer, a predicted value of an average response time to the read request by using the redundancy coefficient, the storage device coefficient, the phase change multiplicity, and the read request indicator.

10. The performance evaluation assistance method according to claim 9, wherein
the predicted value W_{R} of the average response time to the read request is calculated by using the redundancy coefficient, the storage device coefficient, the phase change multiplicity, the read request indicator, and an expression
$${W}_{R} = \frac{ɛ A ( {e}^{\frac{α}{ɛ} ( {X}_{R} - \frac{ɛ}{α A} )} - 1 ) + ɛ}{{X}_{R}} ( {X}_{R} \geq \frac{ɛ}{α A} ) , \\ {W}_{R} = α A ( {X}_{R} \leq \frac{ɛ}{α A} ) \qquad ( 1 )$$
where A, α, ε, and X_{R} are respectively a redundancy coefficient, a storage device coefficient, a phase change multiplicity, and the number of read requests issued per unit time.

11. The performance evaluation assistance method according to claim 9, the performance evaluation assistance method further comprising:
obtaining, by the computer, a response time to a write request;
calculating, by the computer, a predicted value of an average response time to a request issued to the storage apparatus by using the ratio of read requests, the predicted value of the average response time to the read request, and the response time to the write request; and
calculating, by the computer, a multiplicity indicating the number of overlapping read or write requests from or to the storage apparatus per unit time by multiplying the predicted value of the average response time to the request by the input/output indicator.

12. The performance evaluation assistance method according to claim 9, wherein
the calculating the redundancy coefficient and the calculating the storage device coefficient convert the average data amount read from the storage device included in the storage apparatus into an expected value of the number of storage devices to/from which data is written/read in response to a read request or the write request at the time of the read request, and calculate the redundancy coefficient and the storage device coefficient by using the expected value.
